(19) United States
(12) Patent Application Publication
(10) Pub. No.: US 2003/0090353 A1
(43) Pub. Date: May 15, 2003

(54) Contactless transmission of power and information signals in a continuous rotation pan/tilt device

(76) Inventors: Suzette Robinson, Denton, TX (US); Jack Van De Vorst, Kensington (ZA)

Correspondence Address: BRADLEY ARANT ROSE & WHITE LLP, 200 CLINTON AVE. WEST, SUITE 900, HUNTSVILLE, AL, 35801, US

(21) Appl. No.: 10/260,922

(22) Filed: Sep. 30, 2002

Related U.S. Application Data
(60) Provisional application No. 60/326,003, filed on Sep. 28, 2001.

(51) Int. Cl. H01F 7/08

(52) U.S. Cl. 335/220

(57) ABSTRACT

An apparatus for operating a pan/tilt device has been developed. The apparatus is capable of rotating greater than a full circle due to the presence of a single inductive core. The segments of the core are separated by an inductive gap that prevents contact between the segments. Both power and control signals to the pan/tilt device are transmitted across the core.

### CROSS-REFERENCE TO RELATED APPLICATIONS

This application claims priority from U.S. Provisional Patent Application No. 60/326,003 entitled “Contactless Transmission of Power and Information Signals in a Continuous Rotation Pan/Tilt Device” that was filed on Sep. 28, 2001.

### BACKGROUND OF INVENTION

1. Field of the Invention

The invention relates generally to electromechanical devices that adjust the position of its attached components. More specifically, the invention relates to contactless transmission of power and information signals in a continuous rotation pan/tilt device.

2. Background Art

Pan/Tilt devices are used in a variety of industries including security closed circuit television (CCTV), video conferencing, professional/broadcast video, lighting and defense/aerospace. Typical pan/tilt units have integrated or externally attached devices such as cameras, lights, sensors, etc. for which the pan/tilt units provide automated or externally controlled positioning by rotation (or “panning”) and tilting the attached device. Generally, these pan/tilt devices provide limited (less than 360 degrees) rotation.

In conventional pan/tilt systems, a motor that is fixed to the stationary part of the construction (or the “base”) is used to produce rotation of the pan platform (or the “yoke”). On this yoke, a similar construction is built to produce the tilt movement. The motor for the tilt movement is affixed to the yoke and its motion results in the pivoting of the tilt platform on which the device is attached. As a result, the mass to be moved to produce a pan movement includes the entire mass of the tilt motor. This limits the acceleration of these systems due to the inertia caused by the additional mass. The starting and braking torque of a heavy yoke also places stress on the mounting systems of the units. Additionally, the center of gravity of the tilt motor is offset with respect to the rotational center of the yoke. This leads to increased wear of the bearings of these systems, as well as low frequency vibration at high pan speeds.

Driving the tilt motor requires power to be passed from the base to the yoke. In addition to the power requirement, control and video signals are passed from the base to the yoke and vice versa. Generally, this is accomplished by the use of slip-rings that provide a physical connection between the base and the yoke. These parts are generally costly and have a finite life expectancy. Since the slip ring is mounted in the rotational center of the system, it is difficult and costly to replace. In particular, passing power for the motors through slip rings can cause interference with the control and video signals because these signals pass through the same slip ring assembly and associated cable harness.

### SUMMARY OF INVENTION

In some aspects, the invention relates to an apparatus for operating a pan/tilt device, comprising: a first frame that is capable of continuously rotating the pan/tilt device; a second frame that is capable of tilting the pan/tilt device, where the pan/tilt device is attached to the second frame; an inductive core comprising, a stationary segment, a rotating segment, and where the stationary segment and the rotating segment are separated by an inductive gap; and where the inductive core transmits power and control signals for the pan/tilt device across the stationary and rotating segments.

In other aspects, the invention relates to an apparatus for operating a pan/tilt device, comprising: means for continuously rotating the pan/tilt device; means for tilting the pan/tilt device; and means for transmitting control signals to the pan/tilt device through an inductive core.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a perspective view of a continuous rotation pan/tilt device in accordance with one embodiment of the present invention.

FIG. 2 shows a frontal view of a continuous rotation pan/tilt device in accordance with one embodiment of the present invention.

FIGS. 3a and 3b show alternative side views of a continuous rotation pan/tilt device in accordance with one embodiment of the present invention.

FIG. 4 shows an overhead view of a continuous rotation pan/tilt device in accordance with one embodiment of the present invention.

FIG. 5 shows a cross-sectional view of an inductive core in accordance with one embodiment of the present invention.

FIG. 6 shows a block diagram of a power, video and data signal distribution system in accordance with one embodiment of the present invention.

FIG. 7 shows a schematic of the circuitry of a power, video and data signal distribution system in accordance with an alternative embodiment of the present invention.

### DETAILED DESCRIPTION

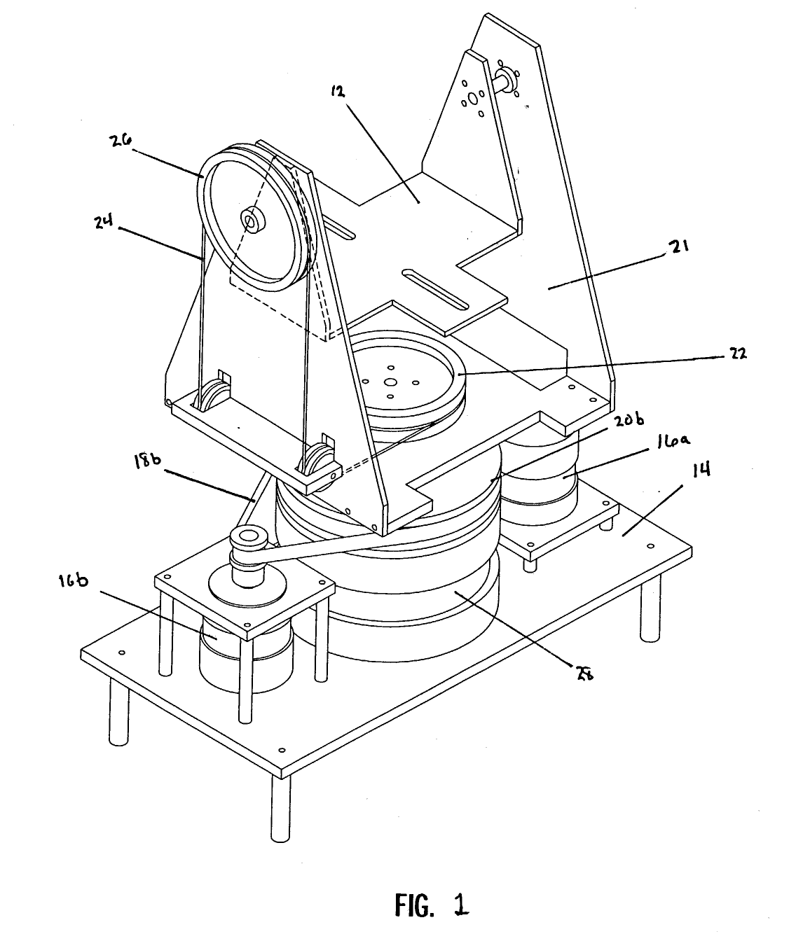

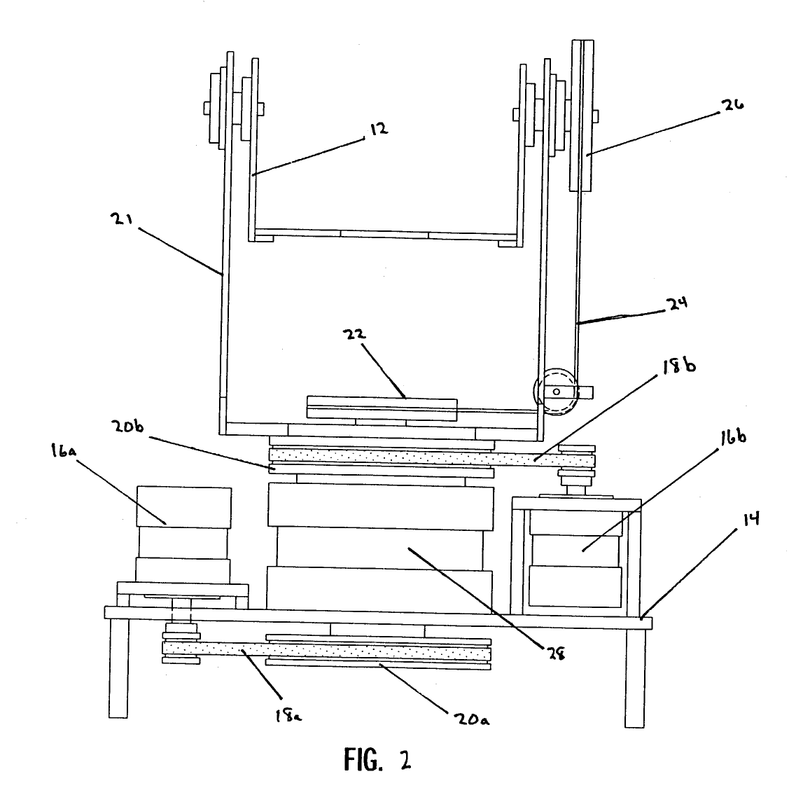

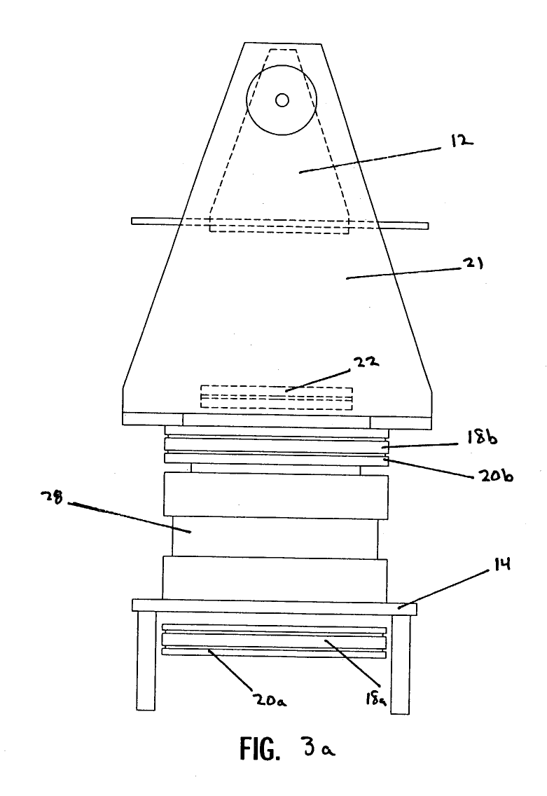

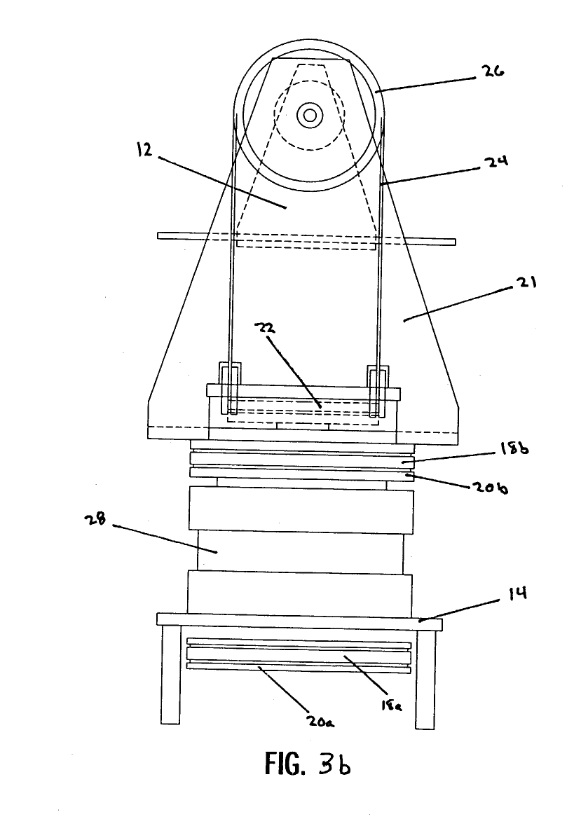

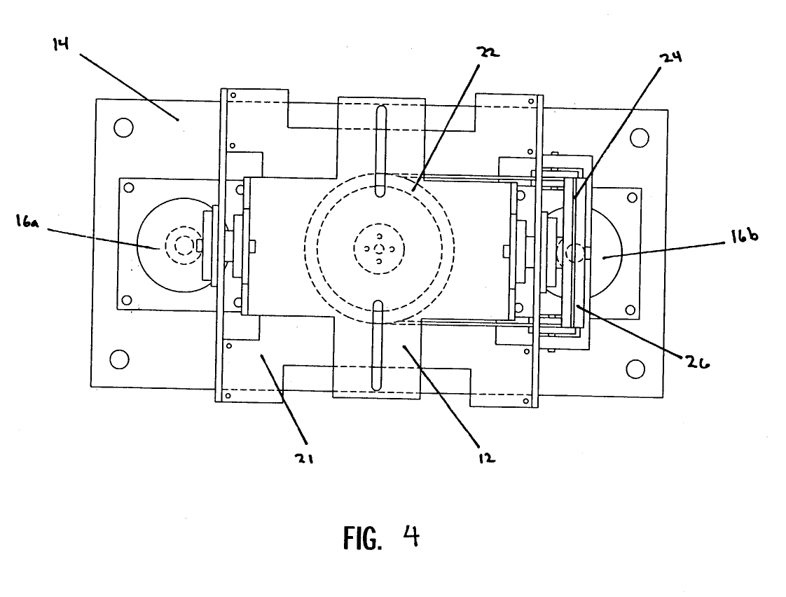

FIGS. 1-5 show different views of an example of one embodiment of a continuous rotation pan/tilt device in accordance with the present invention. Specifically, FIG. 1 shows a perspective view 10 while FIG. 2 shows a frontal view 30. FIGS. 3a and 3b each show alternative side views 32a and 32b. Finally, FIG. 4 shows an overhead view 34 of the apparatus. For the sake of convenience, like features among the different drawings will use the same reference numbers.

The entire apparatus sits on a fixed platform 14 (i.e., the “base”). The rotatable section (i.e., the “yoke”) is rotated or “panned” and tilted by two drive motors 16a and 16b that are mounted on the base. The motors 16a and 16b turn to rotational flywheels 20a and 20b with drive belts 18a and 18b. In alternative embodiments, varying numbers and types of motors and flywheels could be used based on the needs of the system due to weight, stress, reliability, etc. The rotational flywheel 20a rotates a frame mount 21 that contains the equipment mount 12. Tilting the pan/tilt device is accomplished by moving the equipment mount 12 with a tilting flywheel 26 that is driven by a drive flywheel 22 through a tilting drive belt 24. The drive flywheel 22 is turned by a motor 16b through its rotational flywheel 20b and drive belt 18b.

The pan/tilt or “sensing” device (not shown) is attached to the equipment mount 12. Examples of pan/tilt devices include: cameras; lights; antennas; microphones; sensors; or any other type of positionally sensitive device that is known in the art. Any sensing device that gathers information about the environment surrounding the unit and translates this information to an information signal (electrical, optical, etc.) can attached to the equipment mount 12, provided that its electrical and physical specifications do not exceed the capabilities of the unit. The sensing device is most commonly called a camera, and the information signals provided by a camera are referred to herein as video signals. It should be understood, however, that the information signals could be of any type, depending on the nature of the sensing device.

The yoke contains any circuitry required to control the sensing device and sense the tilt platform's position. The base is usually mounted in a housing or on a bracket, and contains the power conditioning, control circuitry, motors and the stationary part of the contactless interface (“interface”). The interface may comprise magnetic, optical or radio frequency elements, in any combination. Ideally, the interface is placed at the rotational center of the system. However, if a radio frequency interface is used, such components need not be at the rotational center.

The yoke contains any circuitry required to control the sensing device and sense its position. The base is usually mounted in a housing or on a bracket, and contains the power conditioning, control circuitry, motors and the stationary part of the contactless interface (“interface”). The interface may comprise magnetic, optical or radio frequency elements, in any combination. Ideally, the interface is placed at the rotational center of the system. However, if a radio frequency interface is used, such components need not be at the rotational center.

The yoke and the base are connected with an inductive core 28. The core serves to transmit control signals from the base to the yoke and vice versa. Control signals can include: power, power feedback, data signals, and video. Typically, power and data signals are transmitted to the yoke and the pan/tilt device from the base. Additionally, the core 28 transmits return data, feedback, and video (if applicable) signals from the yoke and pan/tilt device back to the base. This two-way communication through the core 28 is referred to as “bi-directional” transmission.

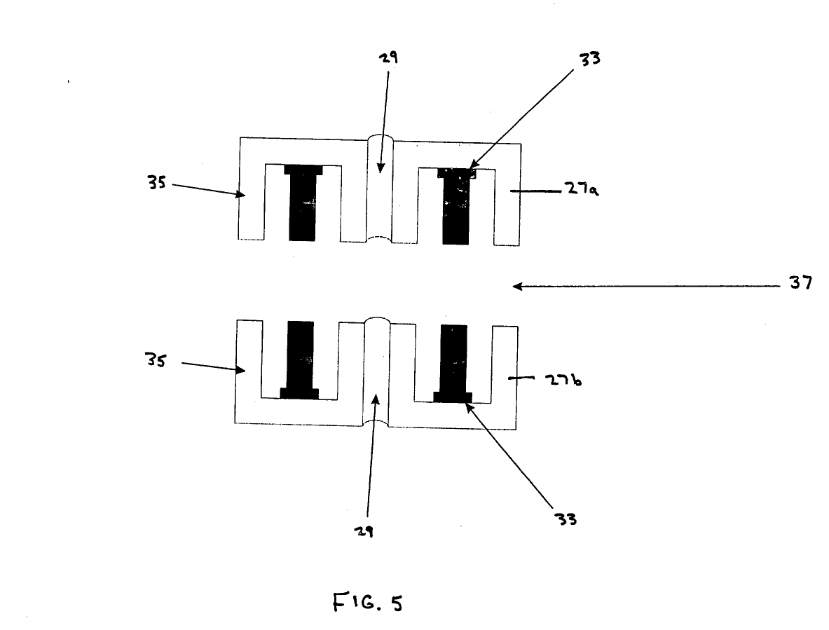

FIG. 5 shows a cross-sectional view of an example of an inductive core 28. The core includes a rotating segment 27a and a stationary segment 27b. Each segment is centered on the same rotational axis 29. The segments themselves include a core frame 35 that encloses the windings 33. The segments are separated by an inductive gap 37 that is sufficient to prevent any contact between the two segments. Typically, the gap is very small (e.g., 0.1 mm) and contains only air. However, other dielectric materials that are commonly used in transformers, capacitors, etc. could be used in alternative embodiments. The windings 33 are typically multiple loops of a conductive material such as copper wire. However, other suitable materials could be used in other embodiments.

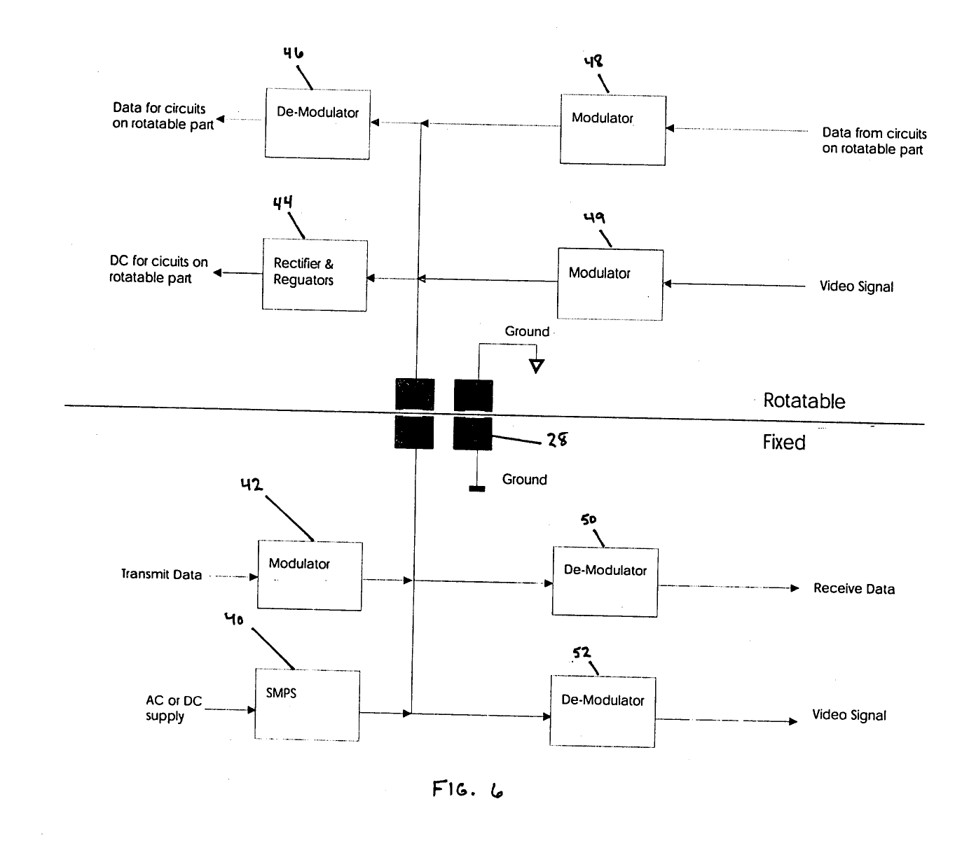

These components form a transformer that transfers power and control signals between the segments. Multiple taps (not shown) are present in the windings of each segment to receive and transmit power or signals. FIG. 6 shows a block diagram 38 of an example of a power, video and data signal distribution system for use with an embodiment of the present invention. Power, in the form of AC or DC, is supplied to a Switched Mode Power Supply (SMPS) circuit 40. Data is supplied to a modulator 42 that modulates the data. Then, both the power and modulated data are transmitted by the fixed segment of the inductive core 28. As the rotating segment of the core 28 receives the power and modulated data, it passes the power to rectifier and regulator circuits 44 where it is then used for the circuits of the yoke. Also, the modulated data is de-modulated 46 before it is used by the circuits of the yoke. Meanwhile, return data and video signals (if applicable) from the yoke are modulated 48 and 49 and transmitted through the core 28. Once these signals are received by the base, they are demodulated 50 and 52.

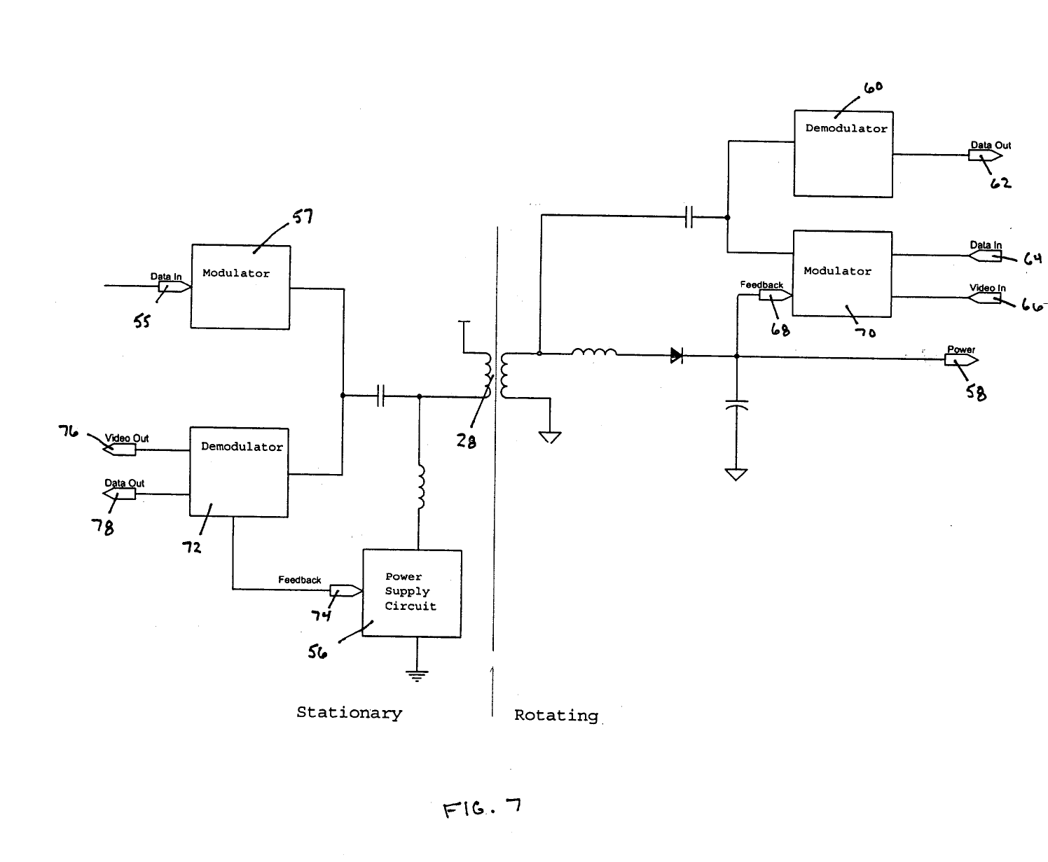

FIG. 7 shows an alternative embodiment 54 of a power, video and data signal distribution system for use with an embodiment of the present invention. This embodiment has a similar configuration as the example previously discussed in FIG. 6 in that Power 56 and modulated data 55 and 57 are transmitted from the base to the yoke through the core 28. Once in the yoke, the power is sent to the electrical circuitry 58 while the data is demodulated 60 before it is sent out. However, the return data and video signals 64 and 66 along with feedback from the power system 68 are modulated by a single modulator before transmission to the base through the core 28. Once in the base, the data signals, video signals, and the power feedback are demodulated by a single unit 72 and sent out for their appropriate uses 74, 76, and 78. While differing configurations of power and control signal distribution systems are shown in FIGS. 6 and 7, it should be understood that components from each embodiment could be combined or deleted in order to form additional alternative embodiments. For example, the video signal could be deleted if the attached device was not a camera.

Modulation and demodulation is a procedure of transmitting a data signal with another signal called “carrier signal” that operates at a certain frequency. The data signal may be transmitted by varying the amplitude of the carrier signal (commonly called amplitude modulation or “AM”). Additionally, the data signal may be transmitted by varying the frequency of the carrier signal within a defined bandwidth around the carrier frequency (commonly called frequency modulation or “FM”). Each type of modulation is available for use embodiments of the present invention.

Examples of suitable modulator components include: NJM2519A, NJM2536A from NJR; and MC1374 from Motorola. Examples of suitable demodulators include: NJM2542 from JRC; TDA 9800 from Phillips; and MC1330AP from Motorola. Examples of suitable SMPS drivers include: NJM3845 from NJR; and MC34063A from Motorola. It should be understood that each of these are just examples and other suitable components that are known in the art may be used.

One advantage of the present invention is that all of the signals transmitted across the core operate at high frequencies of typically 1 MHz and greater. Specifically, the power distribution operates may operate at 1 MHz while the carrier signals may operate from 100-120 MHz. Typically, each modulator and de-modulator circuit operates at different carrier frequencies. For example, separate carrier frequencies may be used to transmit data, return data, video, and power feedback. Additionally, the carrier frequencies may be separated by at least 10 MHz in order to avoid interference, reduce circuit complexity, and preserve signal clarity. For example, this would result in three available carrier frequencies in the 100-120 MHz range: 100 MHz; 110 MHz; and 120 MHz. However, usable frequencies for power and carrying data may range anywhere between 1-120 MHz.

The higher operating frequencies allow for rates of data to be transmitted at very high rates (called “baud rates”) of up to 57,600 bits/second (bps). Additionally, the use of higher frequencies allows for fewer windings and a smaller core to be used which reduces the weight of the apparatus. For example, some embodiments of the present invention include a stationary segment of the core with 44 windings of 0.4 mm wire and a rotating segment of the core with 32 windings of 0.6 mm wire.

In an alternative embodiment, an optical interface relies on a magnetic subsystem for the transfer of power from the base to the yoke, or a self-powered yoke. Control signals, regardless of whether they are analog or digital in nature, are transmitted bi-directionally between the base and yoke. They are transmitted using light emitting diodes (LEDs) and phototransistors, regardless of their operating frequencies. If applicable, the video signal from the sensor on the yoke is transmitted to the base, regardless of whether it is analog or digital in nature, using LEDs and phototransistors, regardless of their operating frequencies. The video and control signals from the yoke to the base may be combined (multiplexed) for transmission on the same optical link.

In an alternative embodiment, a radio frequency system relies on a magnetic subsystem for the transfer of power from the base to the yoke, or a self-powered yoke. Control signals, regardless of whether they are analog or digital in nature, are transmitted bi-directionally between the base and yoke, using radio frequency transmitters and receivers, regardless of their operating frequencies and modulation formats. If applicable, the video signal from the sensor on the yoke is transmitted to the base, regardless of whether it is analog or digital in nature, using radio frequency transmitters and receivers, regardless of their operating frequencies and modulation formats. The video and control signals from the yoke to the base may be combined (multiplexed) for transmission on the same radio link. A self-powered yoke may contain solar cells, batteries, fuel cells or any other such device to power the attached sensor and circuitry. In this embodiment, the control and information signal transfer system may be either magnetic, optical, or radio frequency, or a combination thereof, as described above.

In alternative embodiments, support circuitry exists in the base to generate control signals to: receive and convert digital levels, process and execute commands from a remote controlling entity (e.g., a joystick controller); precisely sense and control the relative speeds of the two motors; send controlling signals to the camera on the yoke; and precisely sense the position of the yoke and tilt platform.

The advantages of the invention include provide an apparatus that can operate a pan/tilt device with continuous (i.e., <360 degree rotation) while supplying power and control signals through a contactless inductive core. Since neither segment of the core is in physical contact with the other, the operational life of the apparatus is extended due to the lack of physical wear and tear. Additionally, both power and control signal transmission is accomplished through bi-directional transmission through a single core.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. An apparatus for operating a pan/tilt device, comprising:
a first frame that is capable of continuously rotating the pan/tilt device;
a second frame that is capable of tilting the pan/tilt device, where the pan/tilt device is attached to the second frame;
an inductive core comprising,
a stationary segment,
a rotating segment, and
where the stationary segment and the rotating segment are separated by an inductive gap; and
where the inductive core transmits power and control signals for the pan/tilt device across the stationary and rotating segments.

2. The apparatus of claim 1, where the control signals comprise data signals.

3. The apparatus of claim 1, where the control signals comprise video signals.

4. The apparatus of claim 1, where the control signals comprise power feedback signals.

5. The apparatus of claim 1, where the inductive gap is filled with a dielectric material.

6. The apparatus of claim 1, where the inductive gap is filled with air.

7. The apparatus of claim 1, where the power and control signals are transmitted at a frequency greater of 1 Megahertz or greater.

8. The apparatus of claim 1, where the control signals are modulated prior to transmission across the inductive core.

9. The apparatus of claim 8, where each modulated control signal has a separate carrier frequency.

10. The apparatus of claim 9, where each separate carrier frequency is separated by 10 MHz.

11. The apparatus of claim 8, where the control signals are modulated by amplitude modulation.

12. The apparatus of claim 8, where the control signals are modulated by frequency modulation.

13. The apparatus of claim 1, where the power transmission is controlled by an optical interface.

14. The apparatus of claim 1, where the power transmission is controlled by a radio frequency interface.

15. An apparatus for operating a pan/tilt device, comprising:
means for continuously rotating the pan/tilt device;
means for tilting the pan/tilt device; and
means for transmitting control signals to the pan/tilt device through an inductive core.
